(19) United States
(12) Patent Application Publication
(10) Pub. No.: US 2002/0149288 A1
(43) Pub. Date: Oct. 17, 2002

(54) Direct current brushless motor with axial winding and radial air-gap

(75) Inventors: Alex Horng, Kaohsiung (TW); Ching-Shen Hong, Kaohsiung (TW); Yin Tso-Kuo, Kaohsiung Hsien (TW)

Correspondence Address: Bacon & Thomas, 625 Slaters Lane - 4th Floor, Alexandria, VA, 22314, US

(73) Assignee: Sunonwealth Electric Machine Industry Co., Ltd., Kaohsiung (TW)

(21) Appl. No.: 09/829,928

(22) Filed: Apr. 11, 2001

(51) Int. Cl. H02K 1/12

(52) U.S. Cl. 310/258; 310/257

(57) ABSTRACT

A direct current brushless motor with axial winding and radial air-gap includes an upper housing and a lower housing each having a shaft seat defining an axial hole. A coil seat is mounted in the upper and lower housing. The poles of the upper and lower silicon steel plates are extended into the central hole of the coil seat, and are arranged in a staggered manner with each other. An insulating layer is provided in the upper and lower housings for isolating the circuit board and the upper housing and the lower housing. A rotor has a rotation shaft pivotally mounted in the axial hole of the upper housing and the lower housing. The rotor has a permanent magnet mating with the positions of the poles of the upper and lower silicon steel plates.

### BACKGROUND OF THE INVENTION

1. Field of the Invention

The present invention relates to a direct current brushless motor with axial winding and radial air-gap, and more particularly to a direct current brushless motor having a more stable and balanced rotation, and having a larger torque.

2. Description of the Related Prior Art

A conventional direct current brushless motor with axial winding and axial air-gap in accordance with the prior art shown in FIGS. 4 and 5 comprises a coil seat 91 whose top and bottom are respectively provided with a silicon steel plate 92. The coil seat 91, the upper and lower silicon steel plates 92, and a circuit board 94 are interconnected by a magnetic conducting tube 93 that is provided with a bearing for pivoting a center shaft 951 of a rotor 95.

In such a conventional direct current brushless motor with axial winding and axial air-gap, the permanent magnet 952 of the rotor 95 surrounds the outermost side of the entire direct current brushless motor. Thus, the rotor 95 is easily hit by an external force during transportation, take or assembly, which will cause the center line of the rotor 95 to deviate from the center lines of the upper and lower bearings in the magnetic conducting tube 93, such that the rotor 95 will produce the eccentric, tilting, wobbling, unstable, and noise problems during rotation. In addition, in the conventional direct current brushless motor with axial winding and axial air-gap, the permanent magnet 952 of the rotor 95 surrounds the circumference of the silicon steel plates 92 on the top and bottom of the coil seat 91 to rotate. Thus, a larger distance is defined between the center shaft 951 of the rotor 95 and the permanent magnet 952, so that the conventional direct current brushless motor will have a smaller rotational torque, and will easily produce a float phenomenon during rotation, and so that the conventional direct current brushless motor cannot perform an even and stable rotation.

### SUMMARY OF THE INVENTION

The primary objective of the present invention is to provide a direct current brushless motor with axial winding and radial air-gap, which may be easily manufactured, has a more stable and balanced rotation, and has a larger torque.

In accordance with the present invention, there is provided a direct current brushless motor with axial winding and radial air-gap includes an upper housing and a lower housing each made of a magnetic conducting material and each having a shaft seat defining an axial hole. A coil seat having an axial winding is mounted in the upper and lower housing, and has a central hole, so that the poles of the upper and lower silicon steel plates are extended into the central hole of the coil seat. The poles of the upper and lower silicon steel plates are arranged in a staggered manner with each other. The upper and lower silicon steel plates each have a periphery provided with a side wall extending toward a vertical direction. In the upper and lower housings, a circuit board is provided, and an insulating layer is provided for isolating the circuit board and the upper housing and the lower housing. A rotor has a rotation shaft pivotally mounted in the axial hole of the upper housing and the lower housing. The rotor has a permanent magnet mating with the positions of the poles of the upper and lower silicon steel plates.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a direct current brushless motor with axial winding and radial air-gap in accordance with the present invention;

FIG. 2 is a front plan cross-sectional assembly view of the direct current brushless motor with axial winding and radial air-gap as shown in FIG. 1;

FIG. 3 is a cross-sectional assembly view of an embodiment of the direct current brushless motor with axial winding and radial air-gap as shown in FIG. 1;

FIG. 4 is an exploded perspective view of a conventional direct current brushless motor in accordance with the prior art; and

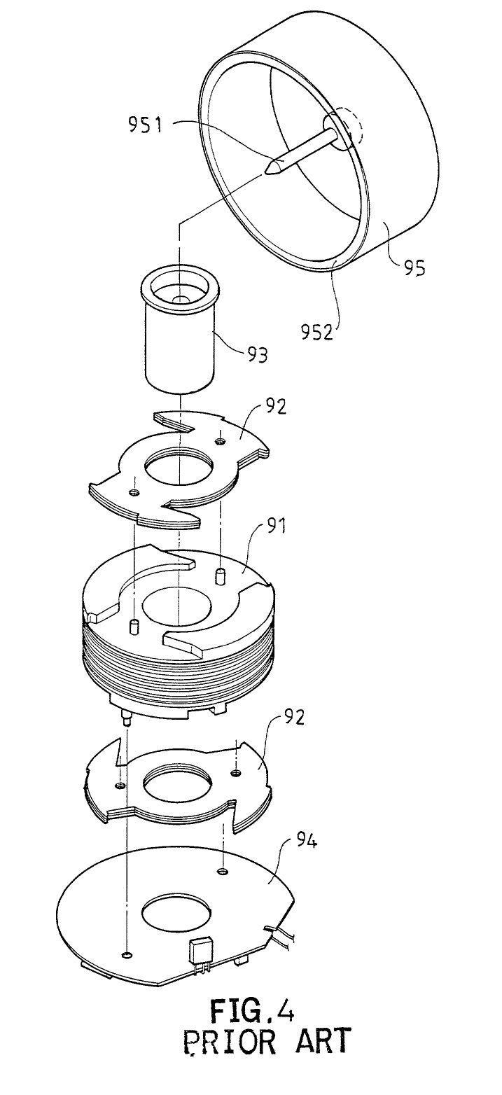

FIG. 5 is a cross-sectional assembly view of the conventional direct current brushless motor as shown in FIG. 4.

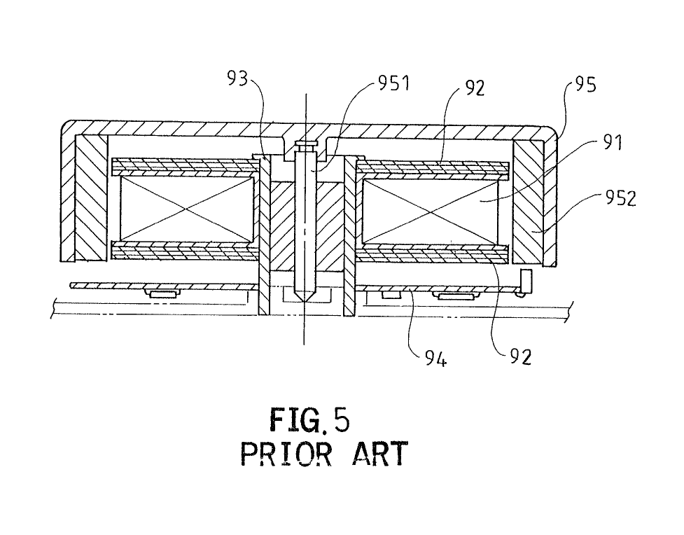

### DETAILED DESCRIPTION OF THE PREFERRED EMBODIMENTS

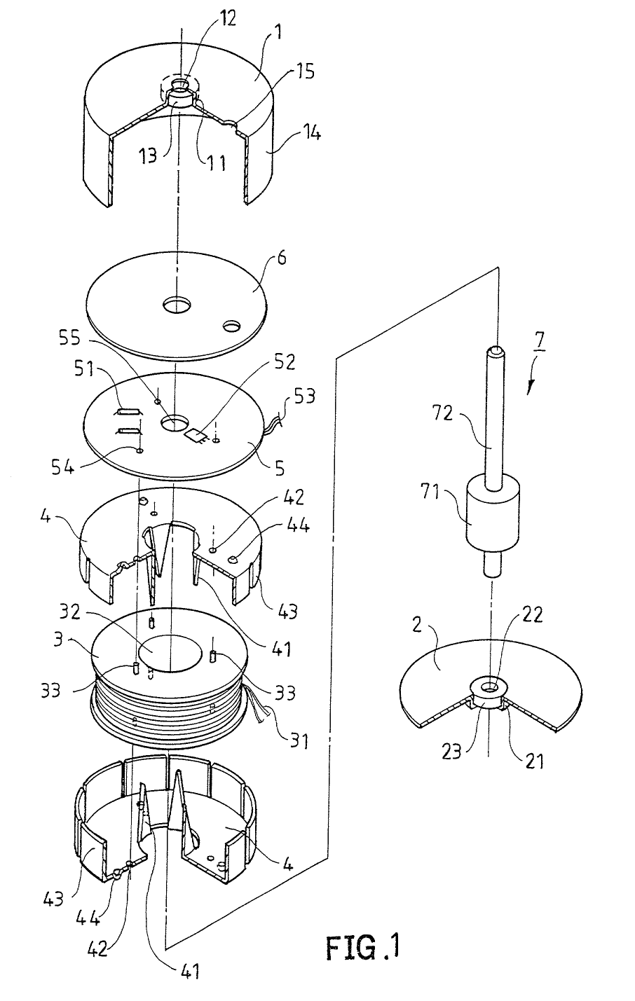

Referring to the drawings and initially to FIG. 1, a direct current brushless motor with axial winding and radial air-gap in accordance with a preferred embodiment of the present invention comprises an upper housing 1, a lower housing 2, a coil seat 3, silicon steel plates 4, a circuit board 5, an insulating layer 6, and a rotor 7.

The upper housing 1 is made of a magnetic conducting material. The upper housing 1 has a shaft seat 11, and the shaft seat 11 has an axial hole 12. The shaft seat 11 and the axial hole 12 are used for supporting the rotor 7 to pivot. In the preferred embodiment, a bearing 13 is placed in the shaft seat 11, for supporting the rotor 7 to rotate. The upper housing 1 has a periphery which may have a magnetic conducting ring 14 extending toward a vertical direction, and the magnetic conducting ring 14 has a magnetic force conducting effect.

The lower housing 2 is made of a magnetic conducting material. The lower housing 2 has a shaft seat 21, and the shaft seat 21 has an axial hole 22. The shaft seat 21 and the axial hole 22 are used for supporting the rotor 7 to pivot. In the preferred embodiment, a bearing 23 is placed in the shaft seat 21, for supporting the rotor 7 to rotate. The lower housing 2 may be combined with the upper housing 1 to form a closed outer housing.

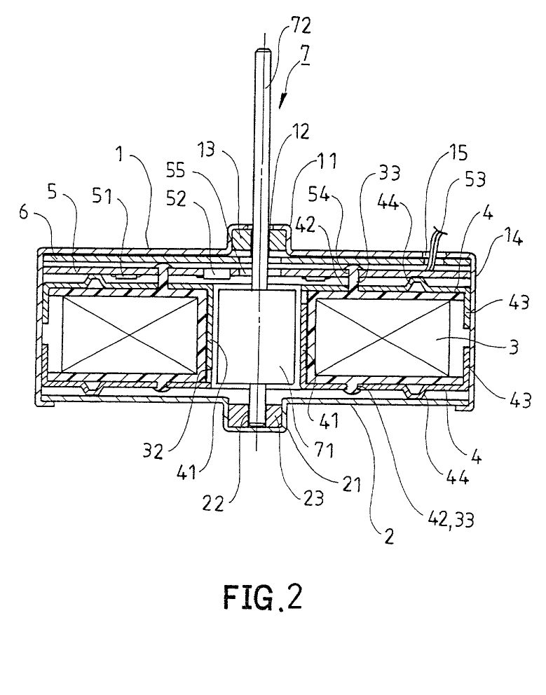

Referring to FIGS. 1 and 2, the coil seat 3 is a housing made of an insulating material which allows a metallic wire with good conducting effect to form an axial winding. The metallic wire has an end 31 head used for an electric power input. The coil seat 3 has a central hole 32 for receiving the poles 41 of the silicon steel plates 4 therein. The coil seat 3 may be provided with positioning posts 33 which may be combined with the silicon steel plates 4 and the circuit board 5.

The silicon steel plates 4 made of a magnetic conducting material are mounted on the upper and lower sides of the coil seat 3, and are located in the upper housing 1 and the lower housing 2. The silicon steel plates 4 may be provided with positioning holes 42, whereby the positioning posts 33 of the coil seat 3 may pass through and combine with the positioning holes 42, so that the silicon steel plates 4 may have a better positioning effect. The silicon steel plates 4 has a central position provided with a plurality of poles 41 extended into the central hole 32 of the coil seat 3, and the poles 41 of the upper and lower silicon steel plates 4 are arranged in a staggered manner with each other. The silicon steel plates 4 located on the upper side and the lower side of the coil seat 3 each have a periphery provided with a side wall 43 extending toward a vertical direction of the coil seat 3. In the preferred embodiment, the side wall 43 may be formed by directly bending the periphery of the silicon steel plate 4. When the side walls 43 of the silicon steel plates 4 located on the upper side and the lower side of the coil seat 3 abut with each other, a magnetic force passageway may be formed therebetween, thereby providing a better magnetic conducting effect. In addition, the silicon steel plate 4 is provided with lugs 44 protruding outward from the surface thereof. The lugs 44 may be rested on the adjacent circuit board 5 or the lower housing 2, thereby keeping a determined distance between the silicon steel plate 4 and the circuit board 5 or the lower housing 2.

The circuit board 5 may be a conventional element, and includes an electronic control member 51, a hall sensor 52, etc. which are necessary to construct an actuating circuit, and includes an electric power cord 53 for introducing the electric power, for actuating the rotor 7 to rotate. The electric power cord 53 may be drawn out from any desired position. In the preferred embodiment, the electric power cord 53 may pass out from the hole 15 of the upper housing 1. The circuit board 5 has at least one hole 54 for combining with the positioning posts 33 of the coil seat 3, and has a central hole 55 for allowing passage of the rotation shaft 72 of the rotor 7.

The insulating layer 6 is used for covering the circuit board 5, thereby isolating the circuit board 5 from the upper housing 1, so that the circuit board 5 cannot contact the upper housing 1, thereby preventing the occurrence of short circuit of the electronic member 51 on the circuit board 5. In the preferred embodiment, the insulating layer 6 may be a plate.

The rotor 7 has a rotation shaft 72 provided with a permanent magnet 71, and the rotation shaft 72 of the rotor 7 has two ends respectively pivotally mounted in the shaft seat 11 of the upper housing 1 and the shaft seat 21 of the lower housing 2 to rotate. The permanent magnet 71 is located in the central hole 32 of the coil seat 3, and mates with the poles 41 of the upper and lower silicon steel plates 4, so that the rotor 7 may be driven to rotate by means of the permanent magnet 71 inducing with the poles 41. Rotation of the rotor 7 may be used for output of power.

Referring to FIG. 2, the direct current brushless motor with axial winding and radial air-gap of the present invention is assembled. The two silicon steel plates 4 are respectively mounted on the upper and lower sides of the coil seat 3, while the poles 41 of the two silicon steel plates 4 are extended into the central hole 32 of the coil seat 3, and the poles 41 are arranged in a staggered manner with each other. The permanent magnet 71 of the rotor 7 is placed in and mates with the poles 41 of the two silicon steel plates 4. The circuit board 5 and the insulating layer 6 are mounted on the outside of one silicon steel plate 4. The rotation shaft 72 of the rotor 7 has two ends respectively pivotally mounted in the shaft seat 11 of the upper housing 1 and the shaft seat 21 of the lower housing 2. The electric power cord 53 of the circuit board 5 may pass out from the hole 15 of the upper housing 1. Thus, when the electric power cord 53 of the circuit board 5 is energized, the poles 41 of the silicon steel plates 4 may induce with the permanent magnet 71 of the rotor 7, so that the rotor 7 is driven to rotate.

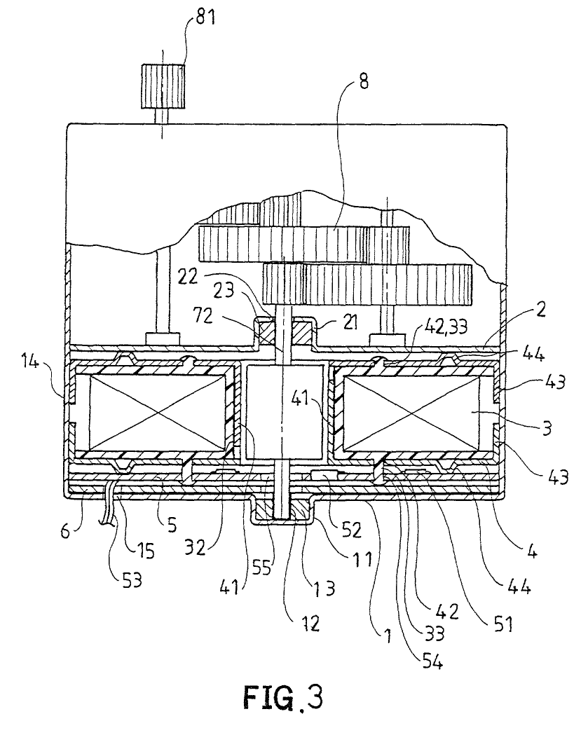

Referring to FIG. 3, in accordance with a preferred embodiment of the direct current brushless motor with axial winding and radial air-gap of the present invention, the rotation shaft 72 of the rotor 7 is connected to a gear set 8, and one terminal wheel 81 is used for power output.

Accordingly, in accordance with the direct current brushless motor with axial winding and radial air-gap of the present invention, the silicon steel plates are respectively mounted on the upper and lower sides of the coil seat, while the poles of the two silicon steel plates are extended into the central hole of the coil seat. The poles are induced with the permanent magnet of the rotor, whereby the rotor is induced in the coil seat to rotate, so that the rotor will not be hit by an external force. The rotation shaft of the rotor will not deviate from the center line of the pole, therefore, will not produce the eccentric, tilting, wobbling, unstable and noise problems. In addition, the permanent magnet of the rotor is induced to rotate in the poles of the silicon steel plates, whereby no distance is defined between the center shaft of the rotor and the permanent magnet, so that the direct current brushless motor will have a larger rotational torque, and will not float during rotation, thereby performing an even and stable rotation.

Although the invention has been explained in relation to its preferred embodiment as mentioned above, it is to be understood that many other possible modifications and variations can be made without departing from the scope of the present invention. It is, therefore, contemplated that the appended claims will cover such modifications and variations that fall within the true scope of the invention.

What is claimed is:

1. A direct current brushless motor with axial winding and radial air-gap, comprising:
an upper housing, made of a magnetic conducting material, having an axial hole;
a lower housing, made of a magnetic conducting material, having an axial hole;
a coil seat, being a housing made of an insulating material formed by a metallic wire functioning as an axial winding, the metallic wire having an end head used for an electric power input, the coil seat having a central hole;
silicon steel plates, respectively mounted on two sides of the coil seat, having a central position provided with poles extended into the central hole of the coil seat, the poles of the upper and lower silicon steel plates are arranged in a staggered manner with each other;
a rotor, having a rotation shaft pivotally mounted in the axial hole of the upper housing and the lower housing, the rotor having a permanent magnet, the permanent magnet located in the central hole of the coil seat, and mating with the poles of the upper and lower silicon steel plates;
an actuating circuit, having an electronic control member, a hall sensor, and having an electric power cord introducing electric power for actuating the rotor to rotate.

2. The direct current brushless motor with axial winding and radial air-gap as claimed in claim 1, wherein the upper housing and the lower housing are additionally provided with a shaft seat, the shaft seat is provided with a bearing therein, the bearing allows pivotal connection of the rotation shaft of the rotor.

3. The direct current brushless motor with axial winding and radial air-gap as claimed in claim 1, wherein the upper housing has a periphery having a magnetic conducting ring extending toward a vertical direction.

4. The direct current brushless motor with axial winding and radial air-gap as claimed in claim 3, wherein the silicon steel plates located on the two sides of the coil seat are tightly combined with the magnetic conducting ring of the upper housing.

5. The direct current brushless motor with axial winding and radial air-gap as claimed in claim 1, wherein the coil seat has positioning posts, and the silicon steel plate is provided with positioning holes, the positioning posts pass through the positioning holes, and combine with the positioning holes.

6. The direct current brushless motor with axial winding and radial air-gap as claimed in claim 1, wherein the silicon steel plates located on the upper side and the lower side of the coil seat each have a periphery provided with a side wall extending toward a vertical direction of the coil seat.

7. The direct current brushless motor with axial winding and radial air-gap as claimed in claim 6, wherein the side walls of the silicon steel plates located on the upper side and the lower side of the coil seat abut with each other.

8. The direct current brushless motor with axial winding and radial air-gap as claimed in claim 1, wherein the silicon steel plate is provided with lugs protruding outward from a surface thereof.

9. The direct current brushless motor with axial winding and radial air-gap as claimed in claim 1, wherein the actuating circuit is mounted on a circuit board.

10. The direct current brushless motor with axial winding and radial air-gap as claimed in claim 9, further comprising an insulating layer, the insulating layer covering the circuit board.

11. The direct current brushless motor with axial winding and radial air-gap as claimed in claim 10, wherein the circuit board covered with the insulating layer is mounted between the silicon steel plate and the upper housing.

12. The direct current brushless motor with axial winding and radial air-gap as claimed in claim 10, wherein the circuit board covered with the insulating layer is mounted between the silicon steel plate and the lower housing.

13. The direct current brushless motor with axial winding and radial air-gap as claimed in claim 1, wherein the circuit board is provided with holes for combining with the positioning posts of the coil seat.
